(19) United States
(12) Patent Application Publication
(10) Pub. No.: US 2016/0115944 A1
(43) Pub. Date: Apr. 28, 2016

(54) DRIVING DEVICE

(71) Applicants: SHENG-LIAN LIN, Taoyuan (TW); YU-YING LIN, Taoyuan (TW); TUNG-YI LIN, Taoyuan (TW)

(72) Inventors: SHENG-LIAN LIN, Taoyuan (TW); YU-YING LIN, Taoyuan (TW); TUNG-YI LIN, Taoyuan (TW)

(21) Appl. No.: 14/582,780

(22) Filed: Dec. 24, 2014

(30) Foreign Application Priority Data
Oct. 23, 2014 (TW) 103136704

(51) Int. Cl. F03G 3/00

(52) U.S. Cl. CPC F03G 3/00

(57) ABSTRACT

A driving device includes a hub portion, a plurality of extension plates and a plurality of driving components. Each extension plate has a first terminal and a second terminal opposite to each other. The first terminal of each extension plate is connected to the hub portion. Each driving component is movably disposed in the respective extension plate. When a first of the plurality of driving component moves along a straight direction, a second of the plurality of driving component moves along a curved direction, thereby resulting in that the first and second driving components corporately drive the hub portion to rotate along a direction, wherein the first and second driving components are disposed opposite to each other.

### FIELD OF THE INVENTION

The present invention relates to a driving device, and more particularly to a driving device having driving ability benefit from gravity.

### BACKGROUND OF THE INVENTION

With the developments of industry and commerce, more and more driving devices (such as motors or engines) for outputting power are used in our daily life. Basically, these driving devices use energy sources (such as oil, electricity or gas) to provide power. However, these energy sources (such as oil, electricity or gas) may not completely satisfy the high demands, such as energy saving and environmental protection, for a better life quality.

At present, the energy conversion of the general energy sources (such as oil, electricity or gas) is pretty low. Generally, the energy conversion rate is about 50%-80%. In addition, these general energies (such as oil, electricity or gas) are limited sources and may pollute our environment thereby affecting the life quality and the ecological conservation.

In addition, for providing the rotation power, the driving device such as a motor may have a secondary energy conversion due to the electric power and wire cables are required; thus, more power is consumed. Accordingly, a certain load is generated to our environment when these driving devices are applied to some specific equations, such as operation, traffic, transpiration, gas delivering or electric power-generating equipments.

Therefore, developing a driving device capable of consuming less energy has become a trend in related technology field due to the high price of the oil and the rising awareness of environment protection.

In summary, with more and more energy are consuming and the lack of the global resources, it is quite important to develop a driving device having enhanced driving ability without additional energy.

### SUMMARY OF THE INVENTION

Therefore, one object of the present invention is to provide a driving device having enhanced driving effect and lower power consumption.

The present invention provides a driving device, which includes a hub portion, a plurality of extension plates and a plurality of driving components. Each extension plate has a first terminal and a second terminal opposite to each other. The first terminal of each extension plate is connected to the hub portion. Each driving component is movably disposed in the respective extension plate. When a first of the plurality of driving component moves along a straight direction, a second of the plurality of driving component moves along a curved direction, thereby resulting in that the first and second driving components corporately drive the hub portion to rotate along a direction, wherein the first and second driving components are disposed opposite to each other.

In one embodiment, each extension plate has a straight slide and a curved slide connected with each other. Each driving component can move on the straight slide or the curved slide of the respective extension plate.

In one embodiment, when the first driving component moves on the straight slide of the respective extension plate from the first terminal to the second terminal thereof along the straight direction, the second driving component, disposed opposite to the first driving component, moves on the curved slide of the respective extension plate from the second terminal to the first terminal thereof along the curved direction.

In one embodiment, the curve slide of a first of the plurality of extension plates is connected to a terminal of the straight slide of a second of the plurality extension plates, wherein the terminal is relatively far from the hub portion and the first and second extension plates are adjacent with each other.

In one embodiment, each one of the plurality of straight slides has a first surface and a second surface opposite to each other. The driving component moves from the first terminal to the second terminal of the respective extension plate when the driving component is located on the first surface of the straight slide of the respective extension plate and moves along the straight direction. The driving component moves from the second terminal to the first terminal of the respective extension plate when the driving component is located on the second surface of the straight slide of the respective extension plate and moves along the straight direction.

In one embodiment, one of the plurality of driving components sequentially moves on the first surface of the straight slide of the respective extension plate along the straight direction from the first terminal to the second terminal thereof, the curved slide of the respective extension plate, the second surface of the straight slide of the respective extension plate along the straight direction from the second terminal to the first terminal thereof, and an edge of the hub portion to the first surface of the straight slide of the respective extension plate.

In one embodiment, each driving component has a chute engaged with the respective extension plate, and the driving component is able to move on the straight slide or the curved slide of the respective extension plate through the chute thereof.

In one embodiment, the driving component has a ball-like structure and is disposed in the respective extension plate and can move on the straight slide or the curved slide of the respective extension plate.

In one embodiment, the aforementioned driving device further includes a plurality of fan blades connected to the extension plates respectively. The fan blades can be driven by a wind power, thereby driving the extension plates to move and consequentially driving the hub portion to rotate.

In one embodiment, the aforementioned driving device further includes a differential. The differential is connected to the hub portion and is activated in response to a rotation of the hub portion.

The present invention further provides a driving device, which includes a hub portion; a plurality of extension plates and a plurality of hinges. The extension plates are surroundingly connected to the hub portion. Each extension plate has a first terminal and a second terminal opposite to each other. The first terminal of each extension plate is connected to the hub portion. The hinges are movably connected to the second terminals of the extension plates respectively. Each hinge can swing relative to the second terminal of the respective extension plate. When the hinges swing downward sequentially by gravity, the extension plates and the hub portion are driven to jointly rotate in a direction.

According to the embodiments described above, it is understood that by using the gravity, the hub portion can be further driven to rotate by the falling of the driving components without the need of additional external energy (such as electric power, water power, wind power, etc) once the hub portion starts to rotate. As a result, the driving device of the present invention has some advantages such as enhanced driving efficiency and lower power consumption.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

FIG. 1 is a schematic front view of a driving device according to an embodiment of the present invention;

FIG. 2 is a schematic front view of a driving device according to another embodiment of the present invention;

FIG. 3 is a schematic front view of a driving device according to still another embodiment of the present invention;

FIG. 4 is a schematic back view of the driving device of FIG. 3; and

FIG. 5 is a schematic front view of a driving device according to yet another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

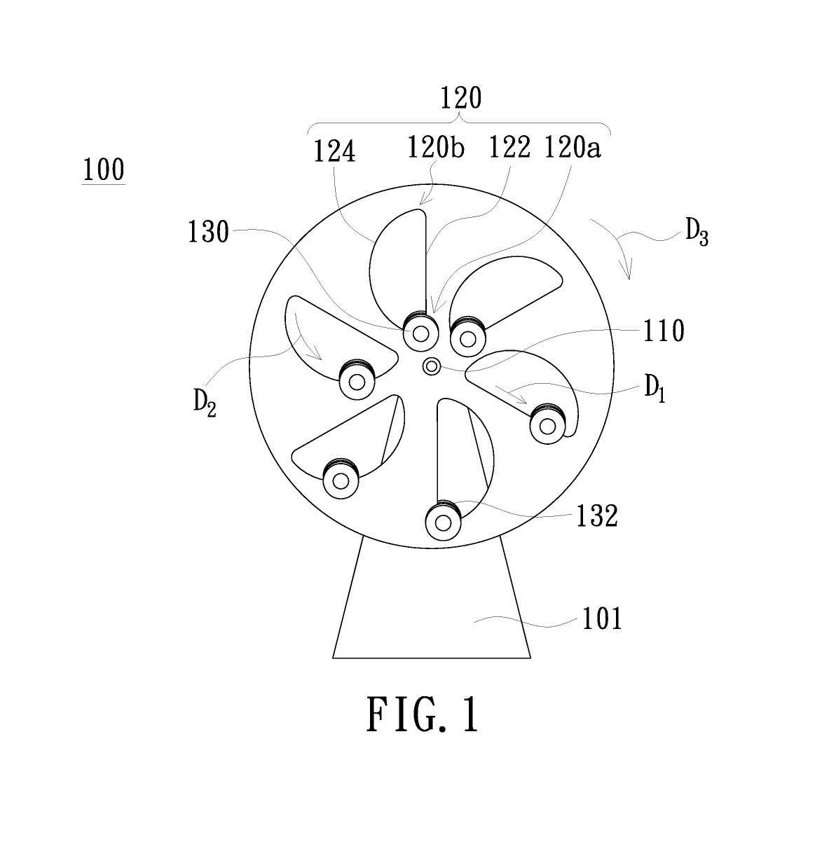

Referring to FIG. 1, which shows a front view of a driving device according to an embodiment of the present invention. As shown in FIG. 1, the driving device 100 in the present embodiment includes a base 101, a hub portion 110, a plurality of extension plates 120 and a plurality of driving components 130. The hub portion 110 is rotatably connected to the base 101. The extension plates 120 are connected to the hub portion 110 and each driving component 130 is disposed in one respective extension plate 120. In this embodiment, the extension plates 120 are integrated together. In one embodiment, the extension plates 120 and the hub portion 110 may have one-piece structure, but the present invention is not limited thereto. Specifically, each extension plate 120 has a first terminal 120a and a second terminal 120b opposite to each other, wherein the first terminal 120a is connected to the hub portion 110.

In addition, each driving component 130 is movably disposed in the respective extension plates 120. Specifically, when the hub portion 110 is driven to rotate by an outer energy (such as electrical power, wind power or water power) thereby causing that at least one of the driving components 130 (e.g., a first driving component 130) is fallen along a straight direction D1 by gravity and another driving component 130 (e.g., a second driving component 130 which is disposed opposite to the first driving component 130) moves along a curved direction D2, the hub portion 110 is further driven to rotate along a direction D3. As a result, the rotation of the hub portion 110 is enhanced without additional external energy once the hub portion 110 starts to rotate and consequentially the consumption of the external energy decreases. In one embodiment, the hub portion 110 has a clockwise rotation while being driven. In another embodiment, the hub portion 110 has a counter-clockwise rotation while being driven.

In this embodiment, each extension plate 120 has a straight slide 122 and a curved slide 124 connected with each other. In the respective extension plate 120, each driving component 130 can move on the straight slide 122 along the straight direction D1 or move on the curved slide 124 along the curved direction D2. Specifically, when one driving component 130 (e.g., a first driving component 130) moves on the straight slide 122 of the respective extension plate 120 along the straight direction D1 thereby being fallen from the first terminal 120a to the second terminal 120b thereof, correspondingly another driving component 130 (e.g., a second driving component 130 which is disposed opposite to the first driving component 130) moves on the curved slide 124 of the respective extension plate 120 along the curved direction D2 thereby moving from the second terminal 120b to the first terminal 120a thereof. In this embodiment, each driving component 130 may further have a chute 132, which is engaged with the respective extension plate 120 so that the driving component 130 can move on the straight slide 122 or the curved slide 124 of the respective extension plate 120 through the chute 132.

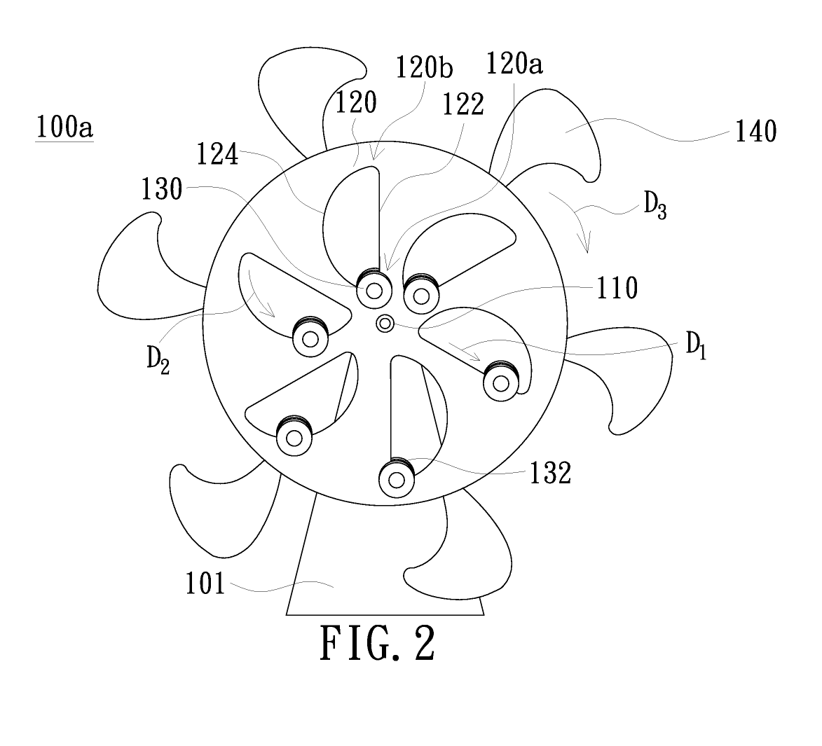

Referring to FIG. 2, which shows a front view of a driving device according to another embodiment of the present invention. As shown, it is to be noted that the driving device 100a in the present embodiment of FIG. 2 and the driving device 100 in the previous embodiment of FIG. 1 have similar components and structures. The main difference between the two driving devices is that the driving device 100a in the present embodiment further includes a plurality of fan blades 140, which are connected to the extension plates 120 respectively. The fan blades 140 can be driven by wind power so as to drive the extension plates 120 to move and consequentially drive the hub portion 110 to rotate. Similar to the driving mean described in FIG. 1, the rotation of the hub portion 110 in the present embodiment is enhanced without additional external energy when the hub portion 110 starts to rotate, and no redundant detail is to be given herein.

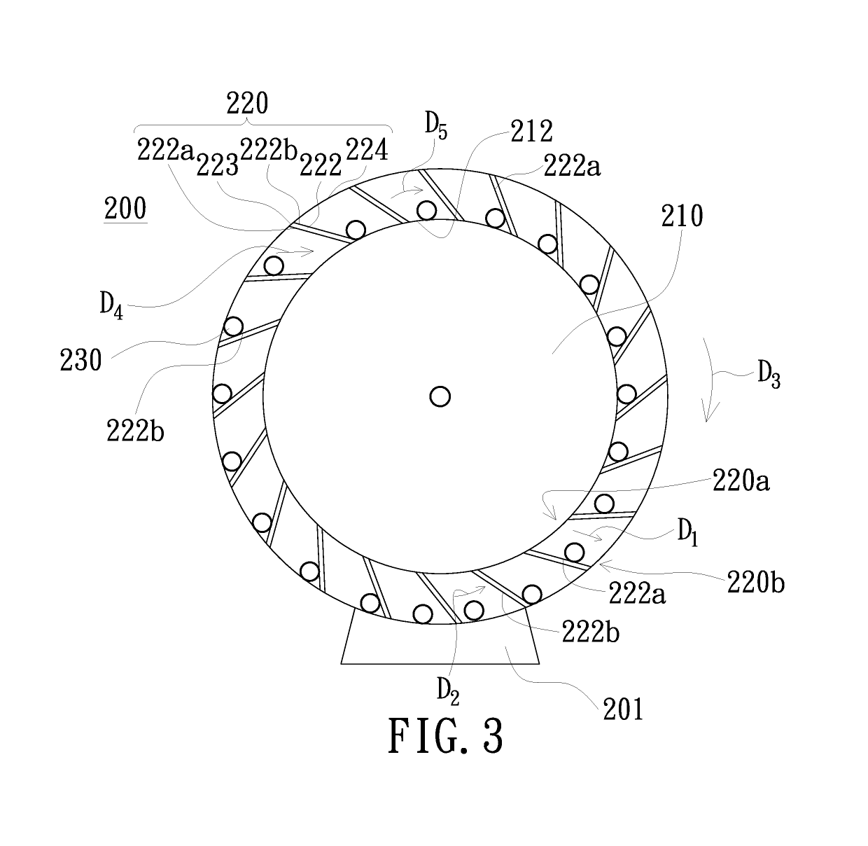

Referring to FIG. 3, which shows a front view of a driving device according to still another embodiment of the present invention. As shown in FIG. 3, the driving device 200 in the present embodiment includes a base 201, a hub portion 210, a plurality of extension plates 220 and a plurality of driving components 230. The hub portion 210 is rotatably connected to the base 201. The extension plates 220 are connected to the hub portion 210, and each driving component 230 is disposed in one respective extension plate 220. Each extension plate 220 has a first terminal 220a and a second terminal 220b opposite to each other; wherein the first terminal 220a is connected to the hub portion 210.

In addition, each driving component 230 is movably disposed in the respective extension plate 220. Specifically, when the hub portion 210 is driven to rotate by an outer energy (such as electrical power, wind power or water power) thereby causing that at least one of the driving components 230 (e.g., a first driving component 230) is fallen along a straight direction D1 by gravity and another driving component 230 (e.g., a second driving component 230 which is disposed opposite to the first driving component 230) moves along a curved direction D2, the hub portion 210 is further driven to rotate along a direction D3. As a result, the rotation of the hub portion 210 is enhanced without additional external energy and consequentially the consumption of the external energy decreases. In one embodiment, the hub portion 210 has a clockwise rotation while being driven. In another embodiment, the hub portion 210 has a counter-clockwise rotation while being driven.

In this embodiment, each extension plate 220 has a straight slide 222 and a curved slide 224 connected with each other. Specifically, the curved slide 224 of each extension plate 220 is connected between the terminals 223 of the straight slides 222 of the adjacent two extension plates 220, wherein the terminal 223 of the straight slide 222 is relatively far from the hub portion 210. Furthermore, in the respective extension plate 220, each driving component 230 may move on the straight slide 222 or move on the curved slide 224.

In this embodiment, each straight slide 222 has a first surface 222a and a second surface 222b opposite to each other. When the hub portion 210 is driven to rotate by an external energy (such as electrical power, wind power or water power) thereby causing that one driving component 230 on the first surface 222a is fallen along the straight direction D1 from the first terminal 220a to the second terminal 220b and another driving component 230 on the second surface 222b is fallen along the straight direction D4 from the second terminal 220b to the first terminal 220a. As a result, the rotation of the hub portion 210 is enhanced without additional external energy once the hub portion 210 starts to rotate and consequentially the consumption of the external energy decreases.

For example, the driving component 230 may move on the first surface 222a of the straight slide 222 of the respective extension plate 220 along the straight direction D1 from the first terminal 220a to the second terminal 220b; then, move on the curved slide 224 of the respective extension plate 220 along the curved direction D2; then, move on the second surface 222b of the straight slide 222 of the respective extension plate 220 along the straight direction D4 from the second terminal 220b to the first terminal 220a; and then move on an edge 212 of the hub portion 210 to the first surface 222a of the straight slide 222 of the respective extension plate 220. In this embodiment, the edge 212 of the hub portion 210 is, but not limited to, a curved edge. As a result, the rotation of the hub portion 210 is enhanced without additional external energy once the hub portion 210 starts to rotate and consequentially the consumption of the external energy decreases.

In this embodiment, the driving component 230 may have a ball-like structure, which is disposed in the respective extension plate 220 and is able to moving on the straight slide 222 or the curved slide 224 of the respective extension plate 220.

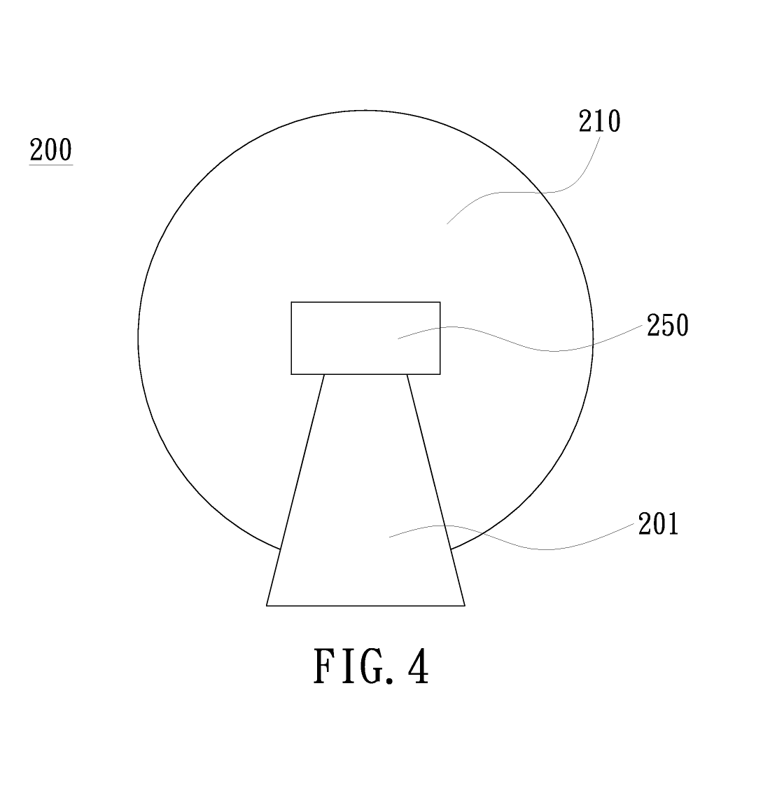

FIG. 4 is a back view of the driving device of FIG. 3. As shown in FIG. 4, the driving device 200 in the present embodiment may further include a differential 250. The differential 250 is connected to the hub portion 210 and can be activated by a rotation of the hub portion 210. Specifically, the hub portion 210 may have a gear part (not shown) engaged with a gear structure (not shown) of the differential 250. When the hub portion 210 is driven to rotate by an external energy (such as electrical power, wind power, water power) so that the gravity-driven driving components 230 in the extension plates 220 can further drive the hub portion 210 to continuously rotate, the gear structure of the differential 250 is driven to rotate by the gear part of the hub portion 210 thereby activating the differential 250. As a result, other related components or devices can be driven to have specific operations through an actuation of the differential 250; however, the present invention is not limited thereto.

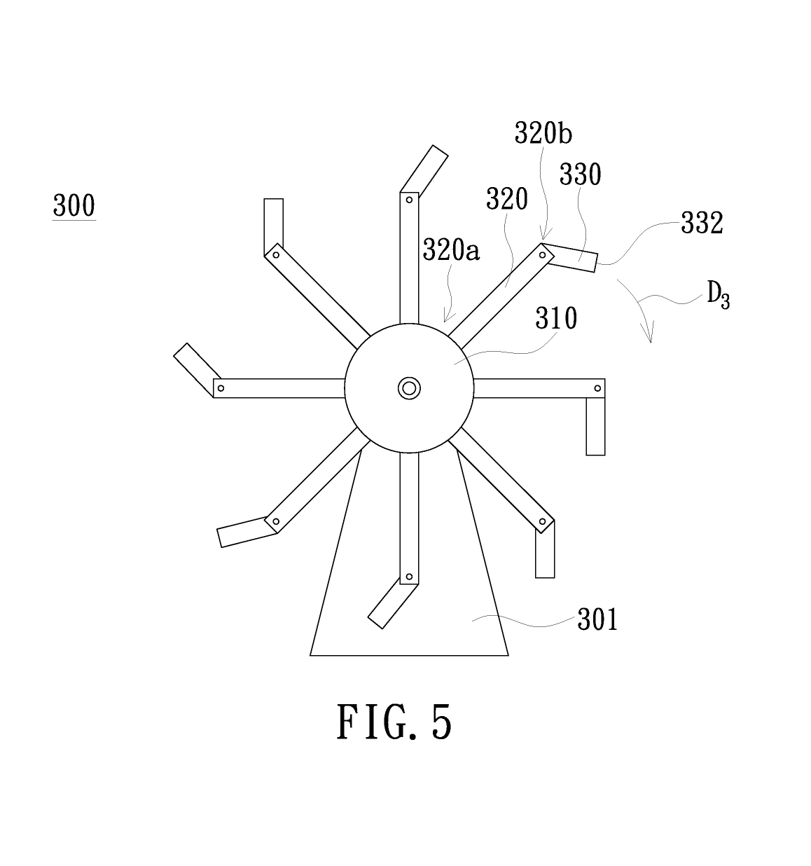

Referring to FIG. 5, which shows a front view of a driving device according to yet another embodiment of the present invention. As shown in FIG. 5, the driving device 300 in the present embodiment includes a base 301, a hub portion 310, a plurality of extension plates 320 and a plurality of hinges 330. The hub portion 310 is rotatably connected to the base 301. Each extension plate 320 has a first terminal 320a and a second terminal 320b opposite to each other; wherein the first terminal 320a is connected to the hub portion 310. Each hinge 330 is movably connected to the second terminal 320b of the respective extension plate 320. When the hub portion 310 is driven to rotate by an external energy (such as electrical power, wind power or water power) so that the extension plates 320 are driven to rotate and the hinges 330 are moved to specific positions, the hinges 330 may swing relative to the second terminals 320b of the extension plates 320 by gravity. Therefore, the terminals 332 of the hinges 330 may sequentially swing downward by gravity and consequentially the extension plates 320 and the hub portion 310 are driven to jointly rotate along a direction D3. In one embodiment, the connection between the hinge 330 and the respective extension plate 320 may be fully moveable. In another embodiment, the connection between the hinge 330 and the respective extension plates 320 may be partially moveable. In a preferred embodiment, the gravity center of each hinge 330 may be located relatively far from the respective extension plate 320.

It should be noted that the driving device 100 in the embodiment as shown in FIG. 1, the driving device 100a in the embodiment as shown in FIG. 2, the driving device 200 in the embodiment as shown in FIG. 3 and the driving device 300 in the embodiment as shown in FIG. 5 may be disposed in vacuum chambers so as to prevent the rotating numbers from being affected by air resistance.

According to the embodiments described above, it is understood that by using the gravity, the hub portion can be further driven to rotate by the falling of the driving components without the need of additional external energy (such as electric power, water power, wind power, etc) once the hub portion starts to rotate. As a result, the driving device of the present invention has some advantages such as enhanced driving efficiency and lower power consumption.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A driving device, comprising:
a hub portion;
a plurality of extension plates, each extension plate having a first terminal and a second terminal opposite to each other, wherein the first terminal of each extension plate is connected to the hub portion; and
a plurality of driving components, each driving component being movably disposed in the respective extension plate, wherein when a first of the plurality of driving component moves along a straight direction, a second of the plurality of driving component moves along a curved direction, thereby resulting in that the first and second driving components corporately drive the hub portion to rotate along a direction, wherein the first and second driving components are disposed opposite to each other.

2. The driving device according to claim 1, wherein each extension plate has a straight slide and a curved slide connected with each other, and each driving component can move on the straight slide or the curved slide of the respective extension plate.

3. The driving device according to claim 2, wherein when the first driving component moves on the straight slide of the respective extension plate from the first terminal to the second terminal thereof along the straight direction, the second driving component, disposed opposite to the first driving component, moves on the curved slide of the respective extension plate from the second terminal to the first terminal thereof along the curved direction.

4. The driving device according to claim 2, wherein the curve slide of a first of the plurality of extension plates is connected to a terminal of the straight slide of a second of the plurality extension plates, wherein the terminal is relatively far from the hub portion and the first and second extension plates are adjacent with each other.

5. The driving device according to claim 4, wherein each one of the plurality of straight slides has a first surface and a second surface opposite to each other, wherein the driving component moves from the first terminal to the second terminal of the respective extension plate when the driving component is located on the first surface of the straight slide of the respective extension plate and moves along the straight direction, wherein the driving component moves from the second terminal to the first terminal of the respective extension plate when the driving component is located on the second surface of the straight slide of the respective extension plate and moves along the straight direction.

6. The driving device according to claim 5, wherein one of the plurality of driving components sequentially moves on the first surface of the straight slide of the respective extension plate along the straight direction from the first terminal to the second terminal thereof, the curved slide of the respective extension plate, the second surface of the straight slide of the respective extension plate along the straight direction from the second terminal to the first terminal thereof, and an edge of the hub portion to the first surface of the straight slide of the respective extension plate.

7. The driving device according to claim 1, wherein each driving component has a chute engaged with the respective extension plate, and the driving component is able to move on the straight slide or the curved slide of the respective extension plate through the chute thereof.

8. The driving device according to claim 1, wherein the driving component has a ball-like structure and is disposed in the respective extension plate and can move on the straight slide or the curved slide of the respective extension plate.

9. The driving device according to claim 1, further comprising a plurality of fan blades connected to the extension plates respectively, wherein the fan blades can be driven by a wind power, thereby driving the extension plates to move and consequentially driving the hub portion to rotate.

10. The driving device according to claim 1, further comprising a differential, wherein the differential is connected to the hub portion and is activated in response to a rotation of the hub portion.

11. The driving device, comprising:
a hub portion;
a plurality of extension plates, surroundingly connected to the hub portion, wherein each extension plate has a first terminal and a second terminal opposite to each other, the first terminal of each extension plate is connected to the hub portion; and
a plurality of hinges, movably connected to the second terminals of the extension plates respectively, each hinge can swing relative to the second terminal of the respective extension plate, wherein when the hinges swing downward sequentially by gravity, the extension plates and the hub portion are driven to jointly rotate in a direction.
